(19) United States
(12) Patent Application Publication
(10) Pub. No.: US 2010/0029241 A1
(43) Pub. Date: Feb. 4, 2010

(54) Rf filter/resonator with protruding tabs

(76) Inventors: Justin Russell Morga, Edgewood, NM (US); Jeffrey J. Nummerdor, Rio Rancho, NM (US); Will Lands, Albuquerque, NM (US); Pat Cottone, Piscataway, NJ (US)

Correspondence Address: DANIEL J. DENEUFBOURG;CTS CORPORATION, 171 COVINGTON DRIVE, BLOOMINGDALE, IL, 60108, US

(21) Appl. No.: 12/462,161

(22) Filed: Jul. 30, 2009

Related U.S. Application Data
(60) Provisional application No. 61/137,726, filed on Aug. 1, 2008.

(51) Int. Cl. H04B 1/16

(52) U.S. Cl. 455/339

(57) ABSTRACT

An RF signal filter/resonator includes a core of dielectric material having top, bottom, and side surfaces. At least one through-hole extends through the core. In one embodiment, the core defines first and second alignment/coupling elements formed on the core for aligning and coupling the filter on and to another coupling element or structure such as a printed circuit board. In one embodiment, the alignment/coupling elements are first and second spaced-apart tabs of different configuration which protrude outwardly from one of the side surfaces, are adapted to be fitted in complementarily configured slots in the printed circuit board, and define respective RF signal input/output pads. In another embodiment, the tabs protrude outwardly from the top surface of the core.

### CROSS-REFERENCE TO RELATED APPLICATION

This application claims the benefit of the filing date of U.S. Provisional Application Ser. No. 61/137,726, filed on Aug. 1, 2008, which is explicitly incorporated herein by reference as are all references cited therein.

### TECHNICAL FIELD

This invention relates to dielectric block filters and resonators for radio-frequency signals.

### BACKGROUND OF THE INVENTION

Ceramic block filters offer several advantages over lumped component filters. The blocks are relatively easy to manufacture, rugged, and relatively compact. In the basic ceramic block filter design, the resonators are formed by generally cylindrical passages, called through-holes, extending through the block from the long narrow side to the opposite long narrow side. The block is substantially plated with a conductive material (i.e. metallized) on all but one of its six (outer) sides and on the inside walls defined by the resonator holes.

One of the two opposing sides defining through-hole openings is not fully metallized, but instead bears a metallization pattern designed to couple input and output signals through the series of resonators. This patterned side is conventionally labeled the top of the block. In some designs, the pattern may extend to sides of the block, where input/output electrodes/pads are formed.

The reactive coupling between adjacent resonators is dictated, at least to some extent, by the physical dimensions of each resonator, by the orientation of each resonator with respect to the other resonators, and by aspects of the top surface metallization pattern. Interactions of the electromagnetic fields within and around the block are complex and difficult to predict.

Although RF signal filters have received widespread commercial acceptance, efforts at improvement on this basic design have continued.

### SUMMARY OF THE INVENTION

The present invention is directed to an RF signal device such as a filter or resonator comprising a rigid core of dielectric material with a top surface, a bottom surface, and a plurality of side surfaces. The core defines one or more through-holes which extend through the core and at least one coupling element on one of the surfaces of the core which is adapted to be coupled to a coupling element on another RF signal device.

In one embodiment, the one coupling element on the core of the RF signal device is a tab protruding outwardly from one of the surfaces of the core of the RF signal device and the coupling element on the other RF signal device is a slot adapted to receive the tab. In one embodiment, the RF signal device can be a filter while the other RF signal device can be a printed circuit board.

In the embodiment where the RF signal device is a filter, the filter can include first and second spaced-apart tabs which protrude outwardly from one of the side surfaces of the core and the core includes first and second areas of metallization which extend onto the first and second tabs. The first and second tabs are adapted to be fitted within respective complementarily configured first and second slots defined in the printed circuit board.

In one embodiment, the first and second areas of metallization extend from the top surface onto the respective first and second tabs on the side surface to define respective first and second input/output electrodes.

In another embodiment, the first and second spaced-apart tabs protrude outwardly from the top surface of the core and the surfaces of the respective tabs are covered with conductive material to define respective first and second input/output electrodes.

In another embodiment, the RF signal device is a resonator including a tab and a slot respectively formed on one of the side surfaces of the core. The tab and the slot are adapted for coupling with a corresponding slot and tab respectively defined on a printed circuit board or another resonator.

In accordance with the invention, the tabs and corresponding slots reduce parasitics and allow filters and/or resonators to be easily and quickly properly aligned and coupled to a printed circuit board or another filter or resonator.

There are other advantages and features of this invention, which will be more readily apparent from the following detailed description of preferred embodiments of the invention, the drawings, and the appended claims.

### BRIEF DESCRIPTION OF THE FIGURES

These and other features of the invention can best be understood by the following description of the accompanying drawings as follows:

FIG. 1A is an enlarged perspective view of an RF signal device in the form of an RF filter incorporating the features of the present invention;

FIG. 1B is a top plan view of a representative printed circuit board adapted to accept the filter of FIG. 1A;

FIG. 1C is a bottom plan view of the printed circuit board of FIG. 1B;

FIG. 2 is a top plan view of the filter of FIG. 1 showing the top surface metallization pattern;

FIG. 3 is a front side elevational view of the filter shown in FIGS. 1A and 2;

FIG. 4 is a right side elevational view of the filter shown in FIGS. 1A and 2;

FIG. 5 is a left side elevational view of the filter shown in FIGS. 1A and 2;

FIG. 6 is a bottom plan view of the filter shown in FIGS. 1A and 2;

FIG. 7 is a side vertical part cross-sectional, part elevational view of the filter of the present invention mounted on the top surface of the printed circuit board of FIGS. 1B and 1C;

FIG. 8 is an enlarged perspective view of another embodiment of an RF signal filter in accordance with the present invention;

FIG. 9 is an enlarged perspective view of an RF signal device in the form of discrete resonators embodying the features of the present invention;

FIG. 10 is a perspective view of the two discrete resonators of FIG. 9 in their coupled relationship;

FIG. 11 is a side elevational view of the two discrete resonators shown in FIG. 10; and

FIG. 12 is an enlarged perspective view of yet another embodiment of an RF signal filter embodying the features of the present invention.

### DETAILED DESCRIPTION OF THE EMBODIMENTS

While this invention is susceptible to embodiment in many different forms, this specification and the accompanying drawings disclose only preferred forms as examples of the invention. The invention is not intended to be limited to the embodiments so described, however.

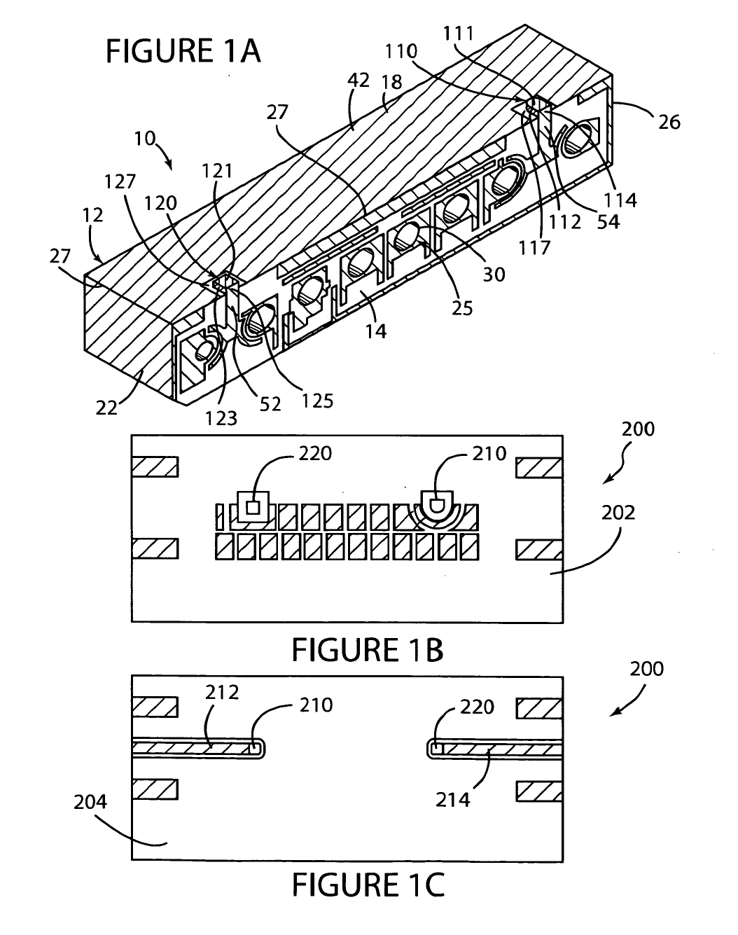

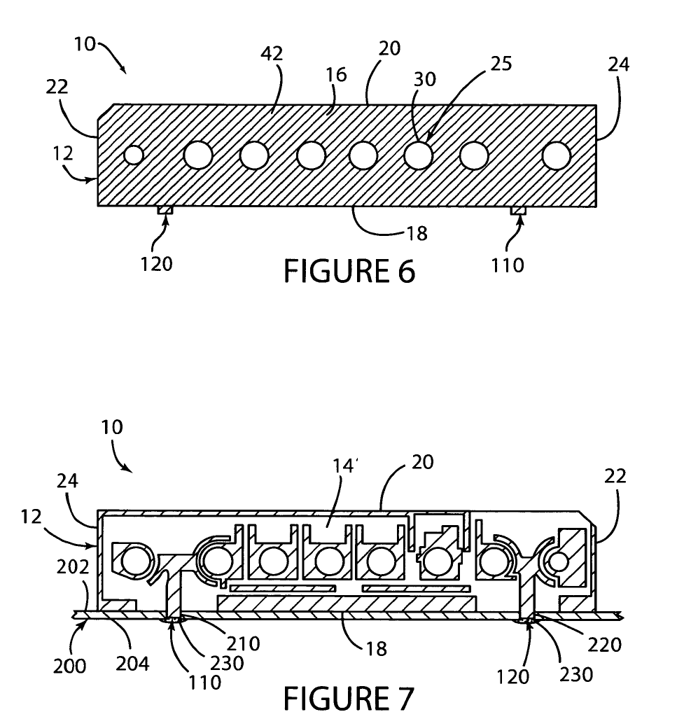

An RF signal device in the form of an RF signal filter 10 embodying the features of the present invention is shown in FIGS. 1A and 2-7 which comprises an elongate, parallelepiped or box-shaped rigid core 12 of ceramic dielectric material. The dielectric material is preferably barium or neodymium ceramic. Preferred dielectric materials for the rigid core 12 have a dielectric constant of about 37. Core 12 has six outer surfaces including a top surface 14, a bottom surface 16, a first side surface 18, an opposite second side surface 20, a third side surface 22, and an opposite fourth side surface 24. Multiple vertical and horizontal edges 26 and 27 respectively are defined by adjacent surfaces of the core 12.

Core 12 includes two spaced-apart, parallel and co-linear input/output coupling/mounting/alignment elements in the form of protruding tabs/projections/fingers/raised connection areas 110 and 120 of dielectric material that protrude outwardly away from the core side surface 18 and, more specifically, outwardly away from the longitudinal core edge 27 which bridges the outer core surfaces 14 and 18. Raised connection area 110 is located adjacent and spaced from core side surface 24 and has a semi-oval shape or configuration while raised connection area 120 is located adjacent and spaced from opposed core side surface 22 and has a square shape or configuration. Raised connection areas or tabs 110 and 120 may also have other shapes or configurations and can be formed by pressing a ceramic power in a mold including respective cavities in the shape of the raised connection tabs 110 and 120 and sintering at the same time that the core 12 is formed.

Raised connection area or tab 110 has a flat end surface or face 111 spaced from and generally parallel to core side surface 18, a generally semi-oval shaped side or lower surface 112 extending between the core side surface 18 and end surface 111 in an orientation generally normal to core side surface 18, and a flat top surface 114 (FIG. 5) which is contiguous/coplanar with the top surface 14 of core 12 and co-linear with the core longitudinal edge 27 which bridges core top surface 14 and core side surface 18.

Raised connection area or tab 120 has a flat end surface or face 121 which is spaced from and generally parallel to core side surface 18, opposed side surfaces 122 and 123 extending between the core side surface 18 and end surface 121 in an orientation generally normal to core side surface 18, and bottom and top surfaces 124 and 125 respectively. Top surface 125 (FIG. 4) is contiguous/coplanar with the top surface 14 of core 12 and co-linear with the core longitudinal edge 27 which bridges core top surface 14 and core side surface 18.

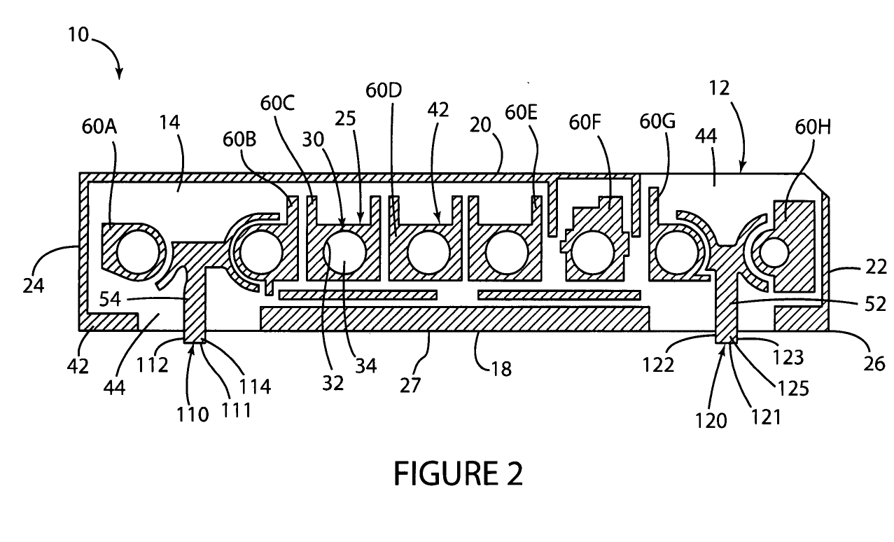

Filter 10 includes a plurality of resonators 25 (FIG. 1A) defined by a plurality of respective metallized spaced-apart and parallel through-holes 30 (FIGS. 1A and 2) which extend through the core 12 between, and in an orientation generally normal to, the top and bottom core surfaces 14 and 16 respectively. The through-holes 30 define respective metallized inner side wall surfaces 32 (FIG. 2).

Core 12 and, more specifically, the outer surfaces 14, 16, 18, 20, 22, and 24 thereof, includes a surface layer pattern of metallized and unmetallized areas. The metallized areas are preferably defined by a surface layer of a conductive material including a wide metallization area or pattern 42 that covers bottom surface 16, side surfaces 20, 22 and 24, portions of top surface 14, and the interior side walls 32 of through-holes 30. Metallized area 42 extends contiguously from within resonator holes 30 towards both top surface 14 and bottom surface 18. Metallization area 42 may also be labeled a ground electrode. Area 42 serves to absorb or prevent transmission of off-band signals.

As shown in FIG. 2, a portion of metallized area 42 defines respective conductive resonator pads 60A, 60B, 60C, 60D, 60E, 60F, 60G and 60H on the top core surface 14 which surround the openings of respective through-holes 30. Resonator pads 60A, 60B, 60C, 60D, 60E, 60F, 60G and 60H are contiguous or connected with metallization area 42 that covers the interior surface 32 of respective through-holes 30; at least partially surround the openings defined in top core surface 14 by the respective through-holes 30; and are shaped to have predetermined capacitive couplings to adjacent resonators and other surface layer metallization areas.

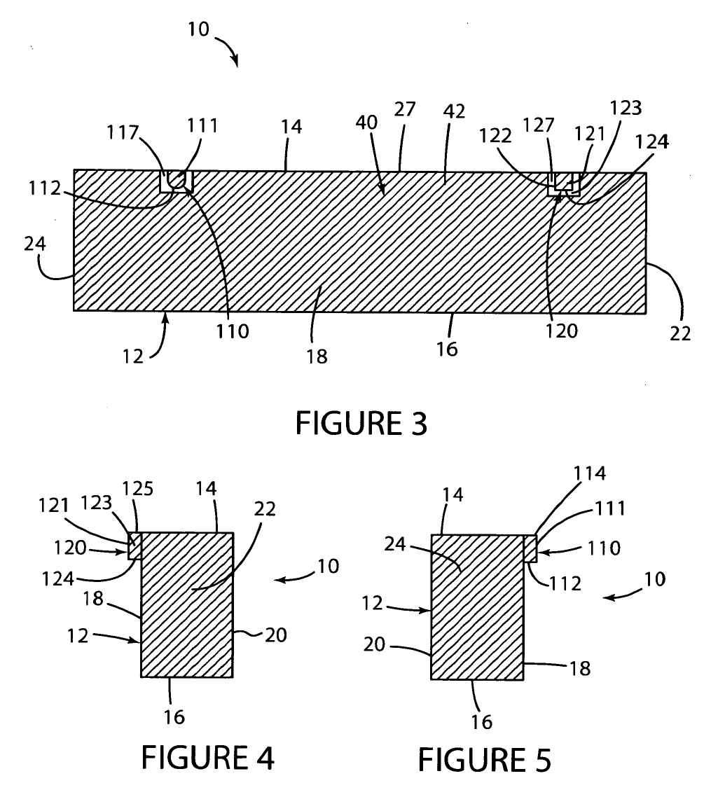

Contiguous unmetallized areas or patterns 44, 117 and 127 (FIGS. 2 and 3) extend over portions of top surface 14 and side surface 18 of core 12. Unmetallized area 44 surrounds metallized resonator pads 60A, 60B, 60C, 60D, 60E, 60F, 60G and 60H. Unmetallized area 117 on side surface 18 (FIG. 3) surrounds raised connection tab 110 and unmetallized area 127 (FIG. 3) on side surface 18 surrounds raised connection tab 120.

As is known in the art, each of the metallized and unmetallized areas has a different configuration or pattern which provides predetermined electrical characteristics. The metallized areas are spaced apart from one another and are therefore capacitively coupled. The amount of capacitive coupling is roughly related to the size of the metallization areas, the separation distance between adjacent metallized portions, the overall core configuration, and the dielectric constant of the core dielectric material. Similarly, surface pattern 42 creates inductive coupling between the metallized areas.

As shown in FIG. 2, surface layer pattern 42 includes a pair of isolated metallized areas 52 and 54 which allow connection of filter 10 to other components or to a printed circuit board 200 as described below in more detail.

A metallized area input/output electrode 52 (FIG. 2), which is at least partially in the form of an elongate strip of conductive material located on the top surface 14 of core 12 extends from the core top surface 14 onto the tab 120 and, more specifically, onto and covering the top surface 125 thereof and then onto and covering the remainder of the surfaces 121, 122, 123, and 124 of the tab 120 (FIGS. 2, 3, and 4) to define an RF signal input/output tab. In the embodiment shown, electrode 52 extends on the top core surface 14 adjacent to and between resonator pads 60G and 60H in the direction of core side surface 18.

A metallized area input/output electrode 54 (FIG. 2), which is also at least partially in the form of an elongate strip of conductive material located on the top surface 14 of core 12 extends from the core outer surface 14 onto the tab 110 and, more specifically, onto and covering the top surface 114 thereof and then onto and covering the remainder of the surfaces 111 and 112 of tab 110 (FIGS. 2, 3, and 5) to define an RF signal input/output tab. Electrode 54 extends on the top core surface 14 adjacent to and between resonator pads 60A and 60B in the direction of core side surface 18.

As is known in the art, the surface layer pattern of metallized and unmetallized areas on core 12 is prepared by providing a rigid core of dielectric material including through-holes 30 to predetermined dimensions. The outer surfaces 14, 16, 18, 20, 22, and 24 and through-hole side walls 32 are then coated with a layer of conductive metal material, preferably silver, by spraying, plating or dipping. The preferred method of coating the dielectric core 12 varies according to the number of cores to be coated. After coating, the surface layer pattern is preferably created by laser ablation of the metal over areas designated to be unmetallized. This laser ablation approach results in unmetallized areas 44, 117, and 127 recessed into the surfaces of core 12 because laser ablation removes both the metal layer and a slight portion of the dielectric material.

RF filter 10 is mountable to a surface mount printed circuit board 200 as shown in FIGS. 1B, 1C, and 7. Printed circuit board 200 includes a top surface 202, a bottom surface 204, and coupling/mounting/alignment elements in the form of slots/apertures 210 and 220 which, in the embodiment shown, are co-linearly aligned and extend between the top and bottom surfaces 202 and 204 of the board 200 and are defined by interior respective board surfaces which have been covered with conductive material. In another embodiment, the slots/apertures 210 and 220 may only partially extend into circuit board 200 and define a bore or cavity or recess (not shown). In the embodiment shown, slot 210 has a semi-oval shape or configuration which is complementarily configured with the shape and configuration of tab 110, i.e., slot 210 is adapted to receive the complementarily configured semi-oval-shaped tab 110 of filter 10. Slot 220 has a square shape or configuration which is complementarily configured with the shape and configuration of the tab 120 i.e., slot 220 is adapted to receive the complementarily configured square-shaped tab 120 of filter 10.

Printed circuit board 200 also includes one or more circuit lines 212 and 214 formed on the bottom surface 204 thereof which are made of strips of conductive material contiguous with the conductive material which covers the interior surfaces of board apertures 210 and 220 and adapted for connection to filter electrodes 52 and 54 using solder 230 following securement of the filter 10 to the board 200.

In accordance with the present invention and shown in FIG. 7, filter 10 is mounted to printed circuit board 200 in a relationship wherein the side surface 18 of filter 10 is seated on and abutted against the top surface 202 of printed circuit board 200 and tabs 110 and 220 protrude and extend into and through the slots 210 and 220 respectively in printed circuit board 200 and, more specifically, in a relationship generally normal to the printed circuit board 200. In the embodiment of FIG. 7, the end faces 111 and 121 of tabs 110 and 220 respectively protrude out of the bottom surface 204 of printed circuit board 200 and solder 230 is applied to the end faces 111 and 121 of respective tabs 110 and 120 and the portion of circuit lines 212 and 214 surrounding the slots 210 and 220 respectively to provide an electrical connection between the electrodes 52 and 54 of filter 10 and the printed circuit board 200.

Dielectric block filters 10 of the type covered by this invention have several advantages. One feature of this invention is the ability of the tabs 110 and 120 to hold the RF filter 10 in place on printed circuit board 200 during soldering operations and, more specifically, prevent the floating or movement of RF filter 10 on printed circuit board 200 during reflow soldering. The use of tabs 110 and 120 increases the reliability of the connections due to the added bond strength between core 12 and printed circuit board 200. This extra strength is needed in severe vibration and high G force environments and applications.

Additionally, and because the tab 110 is semi-oval in shape while the tab 120 is square in shape, the tabs 110 and 120, in combination with the complementarily configured slots 210 and 220 in printed circuit board 200, define co-operating alignment/coupling/mounting elements which makes it impossible to mount or align or position RF filter 10 backwards or incorrectly on printed circuit board 200, i.e., filter 10 can be mounted or coupled to, or aligned on, the printed circuit board 200 in only one direction and orientation.

It is understood of course that numerous variations and modifications of the filter embodiment 10 described above may be effected without departing from the spirit and scope of the novel features of the invention. For example, while the filter 10 shown defines first and second raised tabs 110 and 120, it is understood that only one tab 110 or 120 can be used to effect the desired goal of preventing the floating of the filter 10 on the board 200 or preventing the filter 10 from being mounted “backward” on the board 200.

For another example, it is understood that the tabs 110 and 120 may have different lengths and extend to different depths within printed circuit board 200 to allow the connection point between the filter 10 and printed circuit board 200 to be with separate interior layers or electrodes formed within printed circuit board 200 instead of exterior strips 212 and 214 to reduce the cross talk noise which can be created when connecting to exterior electrodes on a printed circuit board.

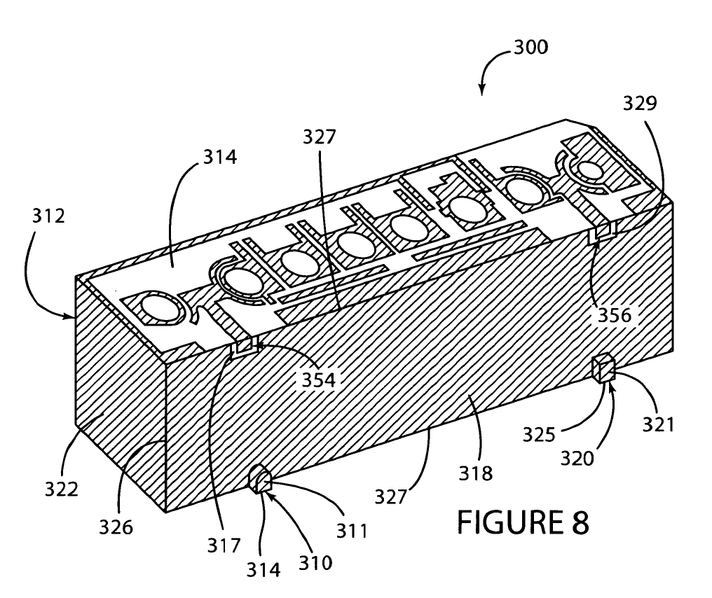

For yet another example, and while the raised mounting tabs 110 and 120 of the filter 10 shown in FIGS. 1A, 2, and 3-7 also define the respective RF signal input/output pads of the filter 10, it is understood that, as shown in FIG. 8, the respective raised tabs 310 and 320 can be formed and located on a portion of side surface 318 separate from respective input/output pads 352 and 354 as described in more detail below.

Filter 300 is similar to filter 10 and includes a core 312 of dielectric material including a top surface 314, a bottom surface (not shown), a first side surface 318, an opposed side surface (not shown), a third side surface 322, and a fourth side surface (not shown).

Multiple vertical edges 326 and horizontal longitudinal edges 327 are defined by the adjacent surfaces of the core 312. Core 312 may include the same surface layer pattern of metallized and unmetallized areas as filter 10 and thus the earlier description thereof with respect to filter 10 is incorporated herein by reference. Filter 300, however, differs from the filter 10 in that input/output electrodes 354 and 356 are defined simply by respective elongate strips of conductive material formed on the top core surface 314 which extend over the core edge 327 which bridges top and side core surfaces 314 and 318 respectively. Electrodes 354 and 356 are surrounded on side surface 318 with respective regions 317 and 329 devoid of conductive material, i.e., respective unmetallized regions of dielectric material.

Filter 300 includes a pair of spaced-apart, parallel and co-linear coupling/mounting/alignment elements in the form of tabs/projections/fingers/raised areas 310 and 320 respectively of dielectric material which protrude outwardly from the side surface 318 of core 312. Tabs 310 and 320, however, differ from the tabs 110 and 120 of filter 10 in that, on filter 300, the tabs 310 and 320 do not form any part of the input/output electrodes 354 and 356 and extend outwardly from the lower longitudinal edge 327 of core 312 which bridges the side core surface 318 and the bottom core surface (not shown) rather than extending outwardly from the upper longitudinal core edge 327 which bridges the top core surface 314 and the side core surface 318 as with the tabs 110 and 120. In the embodiment shown, tab 310 is positioned on core side surface 318 generally below, opposite, and co-linearly aligned with the electrode 354 while the tab 320 is positioned generally below, opposite, and co-linearly aligned with the electrode 356.

Tabs 310 and 320 are otherwise similar in structure to the tabs 110 and 120 respectively and thus the description of tabs 110 and 120 and the respective features and advantages thereof are incorporated herein by reference. Of particular significance is the fact that all of the outside surfaces of the respective tabs 310 and 320 are covered with conductive material and include respective bottom surfaces 314 and 325 which protrude generally normally outwardly away from the core side surface 318 in a relationship co-planar with the bottom surface (not shown) of core 312 and co-linear with the core edge 327 which bridges core side surface 318 and core bottom surface (not shown); and respective front surfaces 311 and 321 which are spaced from and generally parallel to the core side surface 318. Tabs 310 and 320 also differ from tabs 110 and 120 of filter 10 in that tabs 310 and 320 are surrounded by respective regions of metallization as opposed to tabs 110 and 120 which are surrounded by respective unmetallized regions 117 and 127.

Although not described in any detail, it is understood that the invention encompasses still other related embodiments where the tab(s) are formed on any other desired portion of the side surfaces 18 and 318 of filters 10 and 300 respectively.

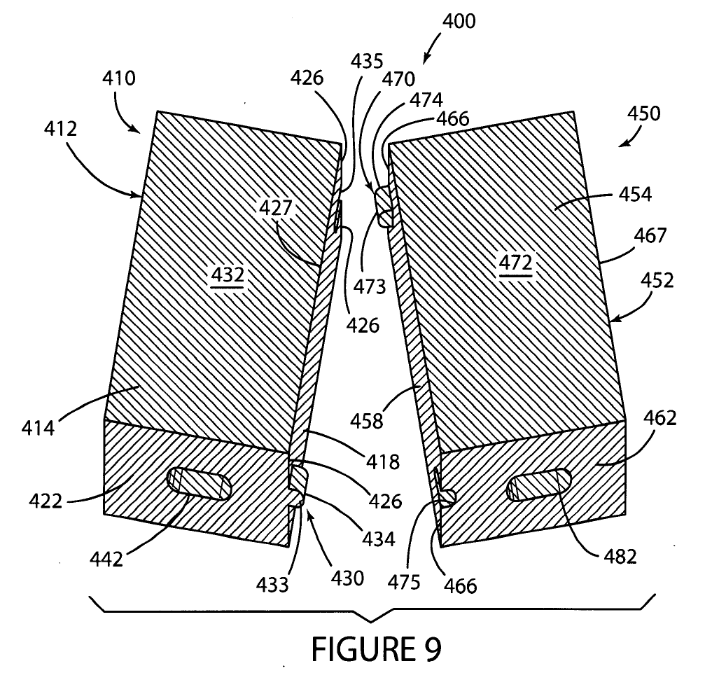

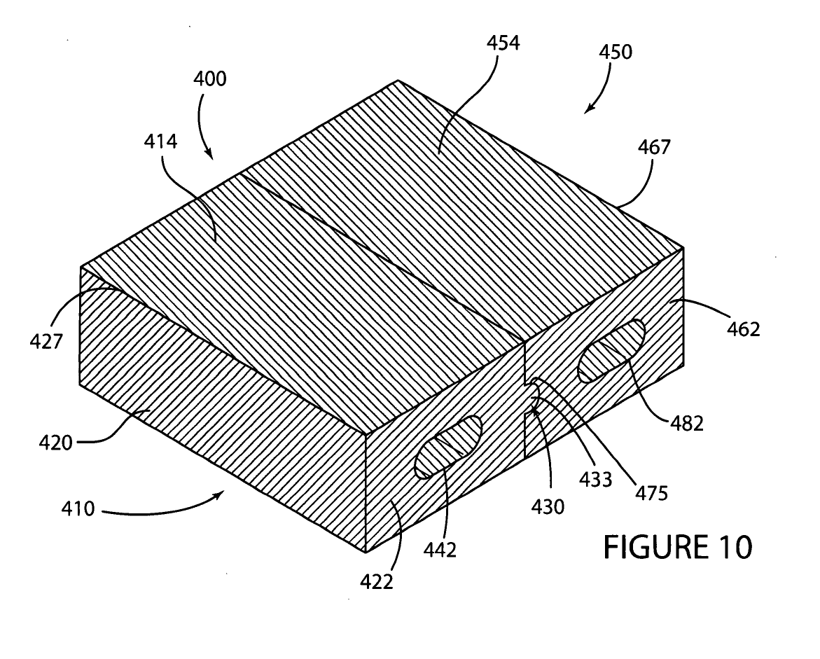

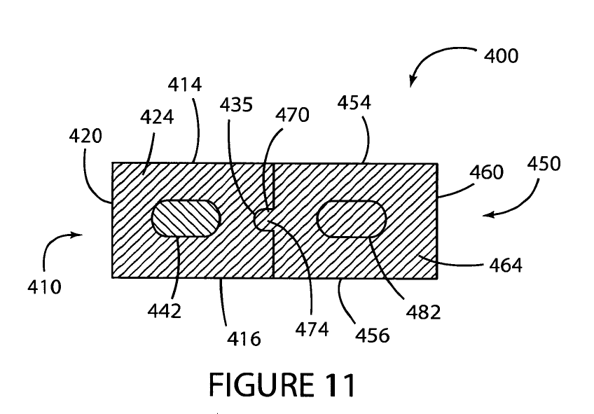

Another embodiment of the RF signal device of the present invention comprising a ceramic resonator structure 400 including at least a pair of individual discrete resonators 410 and 450 is shown in FIGS. 9-11 and described below.

Resonator 410, in a manner similar to filters 10 and 300, has an elongate, parallelepiped or box-shaped rigid core 412 of ceramic dielectric material which is preferably barium or neodymium ceramic and has a dielectric constant of about 37. Core 412 has six outer surfaces: a top surface 414, a bottom surface 416 opposite the top surface 414, a first side surface 418, an opposite second side surface 420 opposite the side surface 418, a third side surface 422, and a fourth side surface 424 opposite the side surface 422. Multiple vertical core edges 426 and horizontal core edges 427 are defined by adjacent sides of core 412. The outside surfaces of the core 412 are covered with a layer of conductive material to define a wide area of metallization 432 on the core 412. Although not shown in the FIGURES, it is understood that surfaces 422 and 424 can each include a pattern of metallized and unmetallized areas.

Core 412 includes a coupling/mounting/alignment element in the form of a raised/protruding tab/projection/finger 430 of dielectric material that extends and protrudes outwardly from and above side surface 418. Tab 430 is positioned generally centrally on core side surface 418 adjacent the vertical edge 426 of core 412 which bridges core side surfaces 418 and 422. Tab 430 includes a plurality of outer surfaces which are all covered with a layer of conductive metallized material including a curvilinear end front face or surface 434 protruding outwardly away from the core surface 418 and a side surface 433 which extends generally normally outwardly from core side surface 418 in a relationship co-planar with the outer surface 422 of core 412 and co-linear with the core edge 426. A resonator is defined in part by a through-hole 442 extending through the core 412 between, and in an orientation generally normal to, the side surfaces 422 and 424. Metallization area 432 extends and covers the interior surface which defines the through-hole 442.

Core 412 also defines another coupling/mounting/alignment element in the form of a groove/slot/recess 435 which is formed in side surfaces 418 and 424 and bridges the vertical core edge 426 which couples respective side surfaces 418 and 424. Slot 435 is positioned generally centrally along the edge 426 which bridges side surfaces 418 and 424 in a relationship opposed and co-linear with the tab 430 which is located along the opposite vertical core edge 426 which bridges side surfaces 418 and 422. Slot 435 is covered with conductive material.

In a similar manner, resonator 450 has an elongate, parallelepiped or box-shaped rigid core 452 of ceramic dielectric material similar in structure and composition to core 412 of resonator 410. Core 452 has six outer surfaces: a top surface 454, a bottom surface 456 opposite the top surface 454, a first side surface 458, a side surface 460 opposite the side surface 458, a third side surface 462, and a side surface 464 opposite the side surface 462. Multiple vertical edges 466 and horizontal edges 467 are defined by adjacent sides of core 452. The outside surfaces of core 452 are covered with a layer of conductive metallized material defining a wide area of metallization 472. Although not shown in any of the FIGURES, it is understood that surfaces 462 and 464 can include a pattern of metallized and unmetallized areas.

Core 452 defines a coupling/mounting/alignment element in the form of raised/protruding tab/projection/finger 470 of dielectric material that extends and protrudes outwardly from and above core side surface 458. Tab 470 is positioned generally centrally on core side surface 458 adjacent the vertical edge 466 of core 412 which bridges core side surfaces 458 and 462. Tab 470 includes a plurality of outer surfaces which are all covered with a layer of conductive metallized material including a curvilinear end front face or surface 473 which protrudes outwardly away from the core surface 458 and a side surface 474 which extends generally normally outwardly away from core side surface 458 in a relationship co-planar with the side core surface 464 and co-linear with core edge 466. A resonator is defined in part by a through-hole 482 extending through the core 452 between, and in an orientation generally normal to, the side core surfaces 462 and 464. Metallization area 472 extends over and covers the interior surface of core 452 which defines the through-hole 482.

Core 452 further defines another coupling/mounting/alignment element in the form of a groove/slot/recess 475 which is formed in side core surfaces 458 and 462 and bridges the vertical core edge 466 which couples respective side core surfaces 458 and 462. Slot 475 is positioned generally centrally along the core vertical edge 466 which bridges side core surfaces 458 and 462 in a relationship opposed and co-linear with the tab 470 which is centrally located along the vertical core edge 466 which bridges core side surfaces 458 and 464. Slot 475 is also covered with conductive material.

Tab 430 defines a coupling or aligning or mounting element or structure on resonator 410 which is adapted to mate with and be seated in the complementarily configured slot 475 in resonator 450 when the two resonators 410 and 450 are coupled together as shown in FIGS. 9 and 10 into a relationship wherein the respective side surfaces 418 and 458 of respective cores 412 and 452 are abutted against each other.

Tab 470 likewise defines a coupling or aligning or mounting element or structure on resonator 450 which is adapted to mate with and be seated in the complementarily configured slot 435 in resonator 410 when the resonators 410 and 450 are coupled together as shown in FIGS. 9 and 10 into a relationship wherein the respective side surfaces 418 and 458 of respective cores 412 and 452 are abutted against each other. An adhesive (not shown) may be applied to surfaces 418 and 458 to bond the resonators 410 and 450 together.

The presence of tabs 430 and 470 and slots 435 and 475 of course allows for the quick and efficient alignment and coupling of the resonators 410 and 450 to each other.

It is understood that, although the respective tabs 430 and 470 and respective slots 475 and 435 are shown as being formed and defined along opposed respective vertical edges 426 and 466 of the respective resonators 410 and 450, the tabs 430 and 470 and slots 475 and 435 could be located and formed anywhere on the respective side surfaces 418 and 458 of respective cores 412 and 452 and still accomplish the same purpose, i.e., quickly and efficiently allowing the alignment and coupling of adjacent resonators. Moreover, it is understood that one of the tabs 430 or 470 and the corresponding one of the slots 475 and 435 may include a shape or configuration different that the other of the tabs 430 and 470 and slots 475 and 435 to further assure the proper coupling orientation and relationship between coupled resonators 410 and 450.

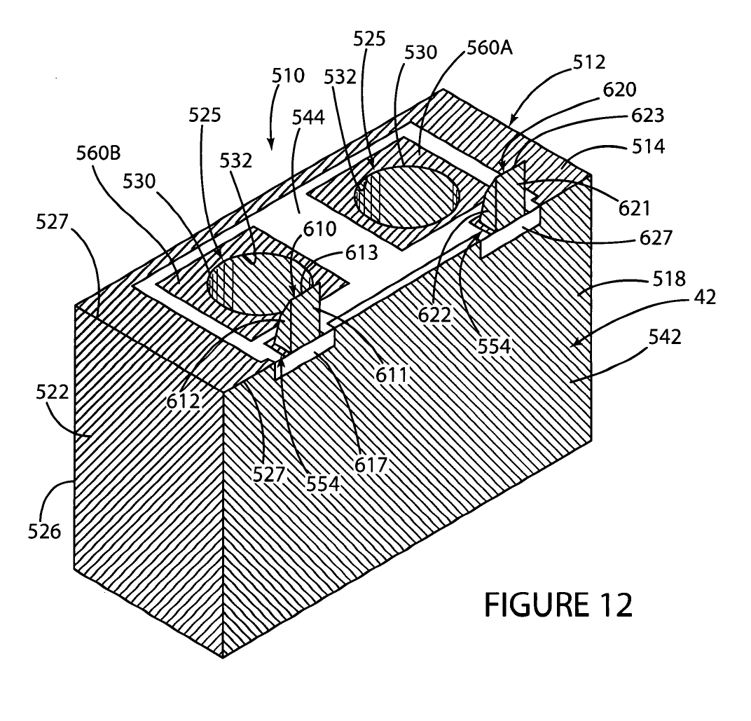

Yet another embodiment of an RF signal device in the form of an RF signal filter 510 embodying the features of the present invention is shown in FIG. 12 which comprises an elongate, parallelepiped or box-shaped rigid core 512 of ceramic dielectric material. The dielectric material is preferably barium or neodymium ceramic. Preferred dielectric materials for the rigid core 512 have a dielectric constant of about 37. Core 512 has six outer surfaces including a top surface 514, a bottom surface (not shown), a first side surface 518, a second side surface (not shown) opposed to side surface 518, a third side surface 522, and a fourth side surface (not shown) opposed to side surface 522. Multiple vertical and horizontal edges 526 and 527 respectively are defined by adjacent surfaces of the core 512.

Core 512 includes two spaced-apart, parallel and co-linear input/output coupling/mounting/alignment elements in the form of tabs/projections/fingers/raised connection areas 610 and 620 of dielectric material that protrude outwardly and upwardly away from the core top surface 514 and, more specifically, outwardly away from the longitudinal core edge 527 which bridges the core surfaces 514 and 518. Raised connection area 610 is located adjacent and spaced from the core side surface 522 while raised connection area 620 is located adjacent and spaced from the core side surface (not shown) opposite the core side surface 522.

Raised connection area or tab 610 includes a plurality of exterior surfaces or faces including: a flat front surface 614 which is contiguous/coplanar with the side surface 518 of core 512 and co-linear with the core edge 527; opposed, parallel flat side surfaces (only one side surface 612 being shown in FIG. 12) extending normally upwardly and outwardly away from the core top surface 514; and a sloped back surface (not shown) opposite the front surface 614. In the embodiment shown, the tab 610 and, more specifically, the surfaces thereof, terminate in a distal edge 613.

Raised connection area or tab 620 includes a plurality of exterior surfaces or faces including: a flat front surface 625 which is contiguous/coplanar with the side surface 518 of core 512 and co-linear with the core edge 527; opposed, parallel, flat side surfaces (only one side surface 622 being shown in FIG. 12) extending normally upwardly and outwardly away from the core top surface 514; and a sloped back surface (not shown) opposite the front surface 614. In the embodiment shown, the tab 620 and, more specifically, the surfaces thereof, terminates in a distal edge 623.

Filter 510 includes a plurality of resonators 525 (FIG. 1A) defined by a plurality of respective metallized spaced-apart and parallel through-holes 530 which extend through the core 512 between, and in an orientation generally normal to, the top and bottom core surfaces. The through-holes 530 define respective metallized inner side wall surfaces 532.

Core 512 and, more specifically, the outer surfaces thereof, include a surface layer pattern of metallized and unmetallized areas. The metallized areas are preferably defined by a surface layer of a conductive material including a wide metallization area or pattern 542 that covers the bottom surface (not shown), all of the side surfaces except for two portions of side surface 518, portions of top surface 514, and the interior side walls 532 of through-holes 530. Metallized area 542 extends contiguously from within resonator holes 530 towards both the top surface 514 and the bottom surface (not shown). Metallization area 542 may also be labeled a ground electrode and serves to absorb or prevent transmission of off-band signals.

A portion of metallized area 542 defines respective conductive resonator pads 560A and 560B on the top core surface 514 which surround respective through-holes 530. Resonator pads 560A and 560B are contiguous or connected with metallization area 542 that covers the interior surface 532 of respective through-holes 530; at least partially surround the openings defined in top core surface 514 by the respective through-holes 530; and are shaped to have predetermined capacitive couplings to adjacent resonators and other surface layer metallization areas.

Contiguous unmetallized areas or patterns 544, 617, and 627 extend over portions of top surface 514 and side surface 518 of core 512. Unmetallized area 544 on top surface 514 surrounds metallized resonator pads 560A and 560B and tabs 610 and 620. Unmetallized area 617 is located on the portion of side surface 518 directly below raised connection tab 610 while unmetallized area 627 is located on the portion of side surface 518 directly below raised connection tab 620 so that tabs 610 and 620 are completely surrounded by unmetallized regions of exposed dielectric material.

As is known in the art, each of the metallized and unmetallized areas has a different configuration or pattern which provides predetermined electrical characteristics. The metallized areas are spaced apart from one another and are therefore capacitively coupled. The amount of capacitive coupling is roughly related to the size of the metallization areas, the separation distance between adjacent metallized portions, the overall core configuration, and the dielectric constant of the core dielectric material. Similarly, surface pattern 42 creates inductive coupling between the metallized areas.

Surface layer pattern 542 additionally includes a pair of isolated metallized areas 552 and 554 of metallized conductive material on the top surface 514 which surround and cover the base of the back and opposed side surfaces of each of the raised connection areas or tabs 610 and 620 and further extend over and cover each of the back, side, and front surfaces 611 and 621 and edges 613 and 623 respectively of each of the raised connection areas or tabs 610 and 620.

As a result of the presence of conductive material on each of the surfaces of respective raised connection areas or tabs 610 and 620, the raised connection areas or tabs 610 and 620 define respective RF signal input/output pads adapted for coupling to the respective RF signal input/output pads (not shown) of a customer's printed circuit board or other RF signal device.

Although not shown in any of the FIGURES, it is understood that the filter 510 is mounted to a printed circuit board similar to the printed circuit board 200 in FIG. 1B in a relationship wherein the side surface 518 of filter 510 is seated on and abutted against the top surface 202 of printed circuit board 200 and the front surfaces 611 and 621 of respective connection areas or tabs 610 and 620 are seated on and abutted against respective conductive input/output pads (not shown) defined on the top surface 202 of printed circuit board 200.

According to the invention, one of the advantages of the input/output connection areas or tabs 610 and 620 protruding out of the top core surface 514 is the reduction of the parasitic effects created by the input/output pads of conventional filters such as, for example, the input/output pads 354 and 356 of the filter 300 shown in FIG. 8 where the input/output pads are formed directly on one of the surfaces of the core. The tabs 610 and 620 also allow the filter 510 to be used in custom applications where space, placement, or other types of limitations do not allow for the use of conventional filters with input/output pads formed directly on the surface of the filter.

### CONCLUSION

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. An RF signal filter comprising:
a core of dielectric material having respective top, bottom, and at least first and second opposed side surfaces;
a plurality of through-holes extending through the core, each of the through-holes defining a resonator;
first and second spaced-apart tabs protruding outwardly from one of the surfaces of the core;
an input electrode defined by a first area of metallization on the first tab; and
an output electrode defined by a second area of metallization on the second tab.

2. The RF signal filter of claim 1, wherein the first tab has a first configuration adapted to complement the configuration of a first slot defined in a printed circuit board and the second tab has a second configuration adapted to complement the configuration of a second slot defined in a printed circuit board.

3. The RF signal filter of claim 1, wherein the first and second tabs protrude outwardly from the top surface of the core.

4. The RF signal filter of claim 1, wherein the first and second tabs protrude outwardly from the first side surface of the core and each includes a top surface generally co-planar with the top surface of the core.

5. An RF signal filter adapted to be mounted on the surface of a printed circuit board, the RF signal filter comprising:
a core of dielectric material having respective top, bottom, and at least a first side surface;
a plurality of through-holes extending between the top and bottom surfaces, each of the through-holes defining a resonator;
first and second spaced-apart fingers of dielectric material protruding outwardly from the first side surface and adapted to be fitted in respective first and second slots defined in the printed circuit board;
a first metallized area on the core extending onto the first finger; and
a second metallized area on the core extending onto the second finger.

6. The RF signal filter of claim 5 further comprising first and second respective unmetallized areas surrounding the first and second fingers respectively to define respective first and second input/output electrodes.

7. The RF signal filter of claim 5, wherein the first and second fingers have first and second configurations and the first and second slots defined in the printed circuit board have first and second configurations complementary with the first and second configurations of the first and second fingers.

8. The RF signal filter of claim 5, wherein the first and second fingers protrude outwardly from an edge of the core between the bottom surface and the first side surface and the respective first and second metallized areas extend from the first side surface onto the first and second fingers respectively.

9. The RF signal filter of claim 5, wherein the first and second fingers protrude outwardly from an edge of the core between the top surface and the first side surface and the respective first and second metallized areas extend from the top surface onto the first and second fingers respectively.

10. An RF signal device comprising:
a core of dielectric material including respective top, bottom, and at least first and second side surfaces;
at least one through-hole extending through the core; and
at least one coupling element on one of the surfaces of the core adapted to be coupled to an other coupling element on an other RF signal device.

11. The RF signal device of claim 10, wherein the one coupling element is a tab protruding outwardly from one of the surfaces of the core.

12. The RF signal device of claim 11, wherein the other coupling element is a slot and the other RF signal device is a printed circuit board.

13. The RF signal device of claim 11 comprising a discrete resonator and the other coupling element is a slot in an other discrete resonator.

14. The RF signal device of claim 11, wherein the tab protrudes outwardly from the first side surface and is covered with conductive material.

15. The RF signal device of claim 14, wherein a strip of conductive material extends from the top surface of the core onto the tab.

16. The RF signal device of claim 11, wherein the tab protrudes outwardly from the top surface and is covered with conductive material.
